(19) United States
(12) Patent Application Publication
(10) Pub. No.: US 2025/0053929 A1
(43) Pub. Date: Feb. 13, 2025

(54) INFORMATION PROCESSING DEVICE, INFORMATION PROCESSING METHOD,AND A NON-TRANSITORY COMPUTER READABLE MEDIUM

(71) Applicant: Matchbox Technologies, Inc., Niigata-shi (JP)

(72) Inventor: Takashi SATO, Niigata-shi (JP)

(73) Assignee: Matchbox Technologies, Inc., Niigata-shi (JP)

(21) Appl. No.: 18/929,728

(22) Filed: Oct. 29, 2024

Related U.S. Application Data
(63) Continuation of application No. PCT/JP2023/016725, filed on Apr. 27, 2023.

(30) Foreign Application Priority Data
Jul. 20, 2022 (JP) 2022-115314

(51) Int. Cl. G06Q 10/1053

(52) U.S. Cl. CPC G06Q 10/1053

(57) ABSTRACT

A server of an employment registrant management system includes, as its functions, a recruitment information accepting and presenting module that presents recruitment information from a business entity to registrants, an employment request accepting module that accepts employment request information, an employment request managing and presenting module that presents the employment request information to the business entity, an employment request selection module that accepts selection of the registrants to be actually employed from the business entity, an offer candidate extracting and presenting module that presents the registrants who may be employed as offer candidate information when there is an opening for employment, an offer target selection accepting module that accepts selection of the registrants to be actually employed as offer targets from the offer candidate information, and an offer target selection notification module that notifies the registrants that the registrants have been selected by the business entity.

### CROSS-REFERENCE TO RELATED APPLICATIONS

This application is a Continuation application of International Application No. PCT/JP2023/016725, filed on Apr. 27, 2023, and the PCT application is based upon and claims the benefit of priority from Japanese Patent Application No. 2022-115314 filed on Jul. 20, 2022, the entire contents of which are incorporated herein by reference.

### FIELD

Embodiments described herein relate generally to an information processing device, an information processing method, and a non-transitory computer readable medium.

### BACKGROUND

In retail stores such as supermarkets and convenience stores, and restaurants such as family restaurants and taverns, non-regular workers such as student part-timers and part-timers are employed as salesclerk in many cases. In order to secure such workers, information of employment seekers is registered in advance, and when there is recruitment information, the information is distributed to the employment seekers, and workers are secured by matching the workers with the recruitment information.

For example, conventional system is disclosed a recruitment matching system that assists matching between employment seekers and business entities (employers). This recruitment matching system is a system that particularly assists matching for daily employment, information of employment seekers is registered in advance, and the system makes it possible to perform distribution of recruitment information, support in selecting appropriate human resources, conclusion of actual contract of employment contract, and then putting employment seekers to work in a short period of time.

Incidentally, the skills required for being employed by business entities as described above include the skills that will be acquired through actual employment, and the skills that are necessary for employment but will not necessarily be acquired through employment, such as official qualifications. It is not easy to centrally manage such skills of different natures. Furthermore, since the skills acquired through actual employment as described above are different depending on the frequency, hours, and the like of the employment, and is also updated every day, it is not easy to manage the skills up to date.

The present disclosure describes a technology that facilitates managing the skills of workers.

### BRIEF DESCRIPTION OF DRAWINGS

FIG. 1 is a diagram illustrating an entire configuration of an employment registrant management system 1.

FIG. 2 is a block diagram illustrating a functional configuration of a terminal device 10 constituting the employment registrant management system 1 in Embodiment 1.

FIG. 3 is a diagram illustrating a functional configuration of a server 20 constituting the employment registrant management system 1 in Embodiment 1.

FIG. 4 is a diagram illustrating examples of data structures of a registrant database 2021 and a recruitment database 2022 stored in the server 20.

FIG. 5 is a diagram illustrating an example of data structure of an offer candidate database 2023 stored in the server 20.

FIG. 6 is a flowchart illustrating an example of a flow for performing registration processing by the employment registrant management system 1 in Embodiment 1.

FIG. 7 is a flowchart illustrating an example of a flow for performing recruitment information accepting processing by the employment registrant management system 1 in Embodiment 1.

FIG. 8 is a flowchart illustrating an example of a flow for performing employment request information accepting processing by the employment registrant management system 1 in Embodiment 1.

FIG. 9 is a flowchart illustrating an example of a flow for performing offer target accepting processing by the employment registrant management system 1 in Embodiment 1.

FIG. 10 is a diagram illustrating an example of a screen that accepts an employment request and that is displayed on the terminal device 10.

FIG. 11 is a diagram illustrating an example of a screen that displays employment applicants and that is displayed on the terminal device 10.

FIG. 12 is a diagram illustrating an example of a screen that displays offer candidates and that is displayed on the terminal device 10.

FIG. 13 is a diagram illustrating a functional configuration of a server 20 constituting an employment registrant management system 1 in Embodiment 2.

### DETAILED DESCRIPTION

In general, to the present disclosure, for an opening in recruitment information, registrants who may be employed by a business entity that has input the recruitment information are extracted as offer candidate information based on employment request information at the business entity that has input the recruitment information or other business entities, or employment schedule information indicating determined employment at the business entity that has input the recruitment information or the other business entities, and the registrants are presented to the business entity that has input the recruitment information. When an input for selecting a registrant who is to be actually employed is received, the registrant is notified that the registrant has been selected as an offer target. Accordingly, it becomes possible to facilitate new employment for securing required shifts.

Hereinafter, embodiments of the present disclosure will be described with reference to the drawings. In the following description, the same numerals are assigned to the same components. The names and functions of them are also the same. Accordingly, a detailed description of them will not be repeated.

### SUMMARY

Hereinafter, an employment registrant management system according to the present disclosure will be described. The employment registrant management system according to the present disclosure is a system that enables smooth recruitment offering and securing of employees by registering information of employment seekers in advance in order to transmit employment requests for recruitment information, and enabling transmission (application) of the employment requests when there is recruitment information for which the employment seekers request employment. This employment registrant management system provides, for example, recruitment information of the working hours during which workers such as student part-timers and part-timers work in retail stores and the like on the assumption of short-term (one-time) employment, i.e., the so-called shifts. In addition, it may be a system that accepts a request for shift, and allows a business entity or an administrator to perform adjustment. The employment registrant management system according to the present disclosure is, for example, a system provided as a web Service, i.e., as a so-called Saas (Software as a Service), by a cloud server or the like, and the system is configured to be accessible by registrants who are registered for employment for a business entity or by a user that is a business entity through predetermined authentication.

The user that utilizes the employment registrant management system according to the present disclosure may be not only a business entity such as a retail store that accepts an employment request, but also an administrator that has a predetermined relationship with the business entity. Here, the business entity is, for example, a company, a manager of a store such as a retail store and a restaurant, or a person who operates a store as an employee of a company that operates a store such as a retail store and a restaurant, or may be a business entity that is a store owner conducting a franchise chain business. In addition, the administrator is a company that operates one or more stores such as retail stores and restaurants, or a person who provides the service of providing human resources to a store such as a retail store and a restaurant, or may be a company conducting a franchise chain business. Note that the administrator may be a company that operates one or more types of stores (of different businesses) such as retail stores and restaurants. Hereinafter, these will be collectively described as the business entity.

It is important for the business entity (employer) as described above that employs workers such as student part-timers and part-timers to have the workers to work during designated hours, i.e., to secure the so-called shifts. This is because, in retail stores such as supermarkets and convenience stores, and restaurants such as family restaurants and taverns, a required number of staff members is different depending on hours, and thus it is necessary to appropriately secure the number of shifts according to hours. On the other hand, since securing more shifts than necessary leads to higher labor costs, it is difficult to employ workers without careful consideration. However, since workers may be absent from work due to illness or emergency circumstances, there is also a demand of securing human resources that can correspond to sudden vacancies.

Therefore, for an opening in the recruitment information (shifts), the employment registrant management system according to the present disclosure extracts, as offer candidate information, registrants (workers) who may be employed by the business entity, based on the employment request information indicating application to the recruitment offered by the business entity that has input the recruitment information or other business entities, or employment schedule information indicating determined employment at the business entity that has input the recruitment information or the other business entities, and presents the registrants to the business entity that has input the recruitment information. Upon reception of an input for selecting, as an offer target, a registrant who is to be actually employed, from the registrants who are offer candidates, the employment registrant management system is configured to notify the registrant that the registrant has been selected as the offer target. Therefore, it is possible to offer the registrants (workers) who may be employed by the business entity to be employed as needed. Accordingly, it is possible to facilitate new employment for securing required shifts.

Furthermore, the employment registrant management system according to the present disclosure is configured to calculate the matching rate indicating the possibility that the registrant presented as the offer information is actually employed by the business entity, and present the matching rate to the business entity. Accordingly, it is possible to determine whether or not the registrant will be employed when hired, and whether or not the registrant is highly likely to be employed.

On the other hand, workers such as student part-timers and part-timers may apply to recruitment information of a plurality of business entities to secure many employment opportunities. In addition, they may apply to the same hours of the recruitment information of the plurality of business entities even when the working hours shown in the recruitment information, i.e., the so-called shift unit, is one-time opportunity. At this time, when hired for the recruitment information by a plurality of business entities, it may be necessary to decline one of them. Therefore, for the reasons of adjustment of hours and the like, when applying for the recruitment information, it is desirable that the response deadlines from the business entities are set.

Therefore, the employment registrant management system according to the present disclosure is configured to accept, from the registrants who are registered for employment by the business entities, the employment request information for the recruitment information, and accept the response deadlines for response information to the employment request information, so as to be able to set the response deadlines. Accordingly, when a registrant (worker) applies for the recruitment information, it is possible to obtain, at an appropriate time, a response as to whether or not the registrant can be employed, by setting the deadline for responses from the business entities.

In addition, in the employment registrant management system according to the present disclosure, in addition to employees (internal employees) who are directly hired by the business entities, the registrants, such as former internal employees who were previously hired by the business entities as full-time employees but already retired, i.e., so-called OBs and OGs, and persons who were hired by the business entities for short terms (for example, even one day is allowed), are registered as external experienced persons, and further, the information of persons who are registered for employment by the business entities and have not been actually employed is also separately managed as external persons.

### First Embodiment

Hereinafter, an employment registrant management system 1 will be described. In the following description, for example, when a terminal device 10 accesses a server 20, the server 20 responds information for generating a screen in the terminal device 10. The terminal device 10 generates and displays the screen based on the information received from the server 20.

### <1 General Configuration of Employment Registrant Management System 1>

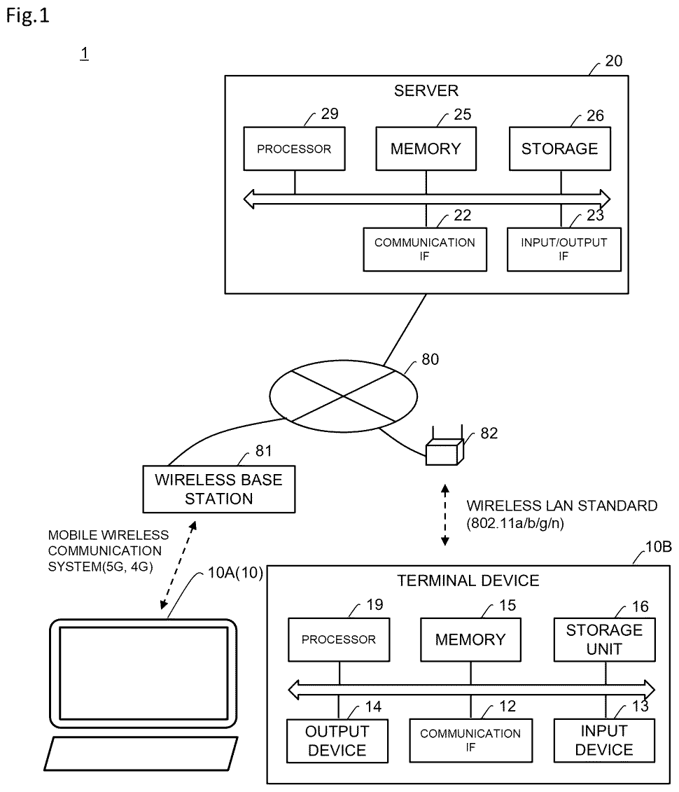

FIG. 1 is a diagram illustrating an entire configuration of the employment registrant management system 1. As illustrated in FIG. 1, the employment registrant management system 1 includes a plurality of terminal devices (FIG. 1 illustrates a terminal device 10A and a terminal device 10B. Hereinafter, they may be collectively referred to as “the terminal device 10”), and the server 20. The terminal device 10 and the server 20 are communicatively connected to each other via a network 80. The network 80 is constituted by a wired or wireless network.

The terminal device 10 is a device operated by each user. Here, users are persons who use the terminal device 10 to perform registration for employment request, presentation of recruitment information, and application for the recruitment information, which are functions of the employment registrant management system 1, and includes the above-described registrants (including persons who are going to perform registration), business entities, and the like. The terminal device 10 is realized by a stationary PC (Personal Computer), a laptop PC, or the like. In addition, the terminal device 10 may be, for example, a tablet corresponding to mobile communication systems, or a mobile terminal such as a smart phone.

The terminal device 10 is communicatively connected to the server 20 via the network 80. The terminal device 10 is connected to the network 80 by communicating with communication equipment, such as a wireless base station 81 corresponding to communication standards such as 4G, 5G, and LTE (Long Term Evolution), and a wireless LAN router 82 corresponding to the wireless LAN (Local Area Network) standards such as IEEE (Institute of Electrical and Electronics Engineers) 802.11. As illustrated in FIG. 1 as the terminal device 10B, the terminal device 10 includes a communication IF (Interface) 12, an input device 13, an output device 14, a memory 15, a storage unit 16, and a processor 19.

The communication IF 12 is an interface for inputting and outputting signals for the terminal device 10 to communicate with an external device. The input device 13 is an input device (for example, a keyboard, a touch panel, a touchpad, a pointing device such as a mouse, and the like) for accepting an input operation from a user. The output device 14 is an output device (a display, a speaker, and the like) for presenting information to the user. The memory 15 is for temporarily storing a program, data to be processed by the program, and the like, and is, for example, a volatile memory such as a DRAM (Dynamic Random Access Memory). The storage unit 16 is a storage device for saving data, and is, for example, a flash memory or an HDD (Hard Disc Drive). The processor 19 is hardware for executing a set of instructions written in the program, and includes an arithmetic unit, a register, and a peripheral circuit.

The server 20 is a device that manages information regarding the registrants registered by the business entities as employment seekers, and the like. The server 20 accepts registration information from a user who is an employment seeker, and registers the user as a registrant. The server 20 accepts and registers recruitment information from a user who is a business entity, and presents the recruitment information to accept an application from the registrant. In addition, the server 20 presents an employment request for the recruitment information to the business entity to accept selection of an employment seeker, presents offer candidate information for an opening in the recruitment information to accept selection of an employment seeker, and issues a notification to the selected employment seeker.

The server 20 is a computer connected to the network 80. The server 20 includes a communication IF 22, an input/output IF 23, a memory 25, a storage 26, and a processor 29.

The communication IF 22 is an interface for inputting and outputting signals for the server 20 to communicate with an external device. The input/output IF 23 functions as an interface for an input device for accepting an input operation from the user, and an output device for presenting information to the user. The memory 25 is for temporarily storing a program, data to be processed by the program, and the like, and is, for example, a volatile memory such as a DRAM (Dynamic Random Access Memory). The storage 26 is a storage device for saving data, and is, for example, a flash memory or an HDD (Hard Disc Drive). The processor 29 is hardware for executing a set of instructions written in the program, and includes an arithmetic unit, a register, and a peripheral circuit.

### <1.1 Configuration of Terminal Device 10>

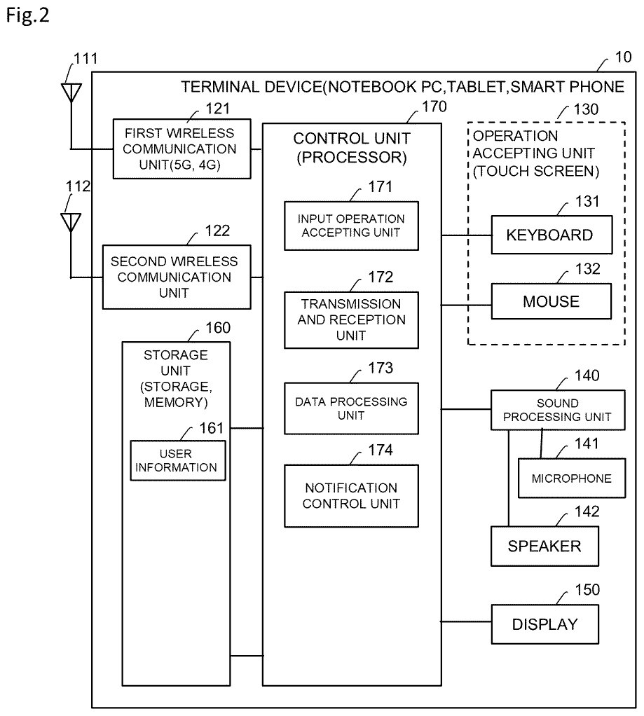

FIG. 2 is a block diagram illustrating a functional configuration of the terminal device 10 constituting the employment registrant management system 1 of Embodiment 1. As illustrated in FIG. 2, the terminal device 10 includes a plurality of antennas (an antenna 111, an antenna 112), wireless communication units (a first wireless communication unit 121, a second wireless communication unit 122) corresponding to the respective antennas, an operation accepting unit 130 (including a keyboard 131 and a mouse 132), a sound processing unit 140, a microphone 141, a speaker 142, a display 150, a storage unit 160, and a control unit 170. The terminal device 10 also has functions and configurations (for example, a battery for holding power, and a power supply circuit that controls the supply of power to each circuit from the battery, and the like) that are not particularly illustrated in FIG. 2. As illustrated in FIG. 2, each block included in the terminal device 10 is electrically connected by buses and the like.

The antenna 111 radiates a signal emitted by the terminal device 10 as an electric wave. In addition, the antenna 111 receives an electric wave from the space, and supplies a received signal to the first wireless communication unit 121.

The antenna 112 radiates a signal emitted by the terminal device 10 as an electric wave. In addition, the antenna 112 receives an electric wave from the space, and supplies a received signal to the second wireless communication unit 122.

The first wireless communication unit 121 performs modulation and demodulation processing for transmitting and receiving signals via the antenna 111, and the like, for the terminal device 10 to communicate with other wireless devices. The second wireless communication unit 122 performs modulation and demodulation processing for transmitting and receiving signals via the antenna 112, and the like, for the terminal device 10 to communicate with other wireless devices. The first wireless communication unit 121 and the second wireless communication unit 122 are communication modules including a tuner, an RSSI (Received Signal Strength Indicator) calculation circuit, a CRC (Cyclic Redundancy Check) calculation circuit, a high frequency circuit, and the like. The first wireless communication unit 121 and the second wireless communication unit 122 perform modulation and demodulation and frequency conversion of radio signals that are transmitted and received by the terminal device 10, and supply received signals to the control unit 170.

The operation accepting unit 130 includes a mechanism for accepting an input operation by the user. Specifically, the operation accepting unit 130 includes the keyboard 131 and the mouse 132. Note that the operation accepting unit 130 may be constituted by using, for example, a capacitive touch panel, so as to constitute a touch screen that detects a contact position of the user on the touch panel.

The keyboard 131 accepts an input operation by the user of the terminal device 10. The keyboard 131 is a device for inputting characters, and outputs the input characters to the control unit 170 as input signals.

The mouse 132 accepts an input operation by the user of the terminal device 10. The mouse 132 is a pointing device for selecting displayed materials that are displayed on the display 150, and outputs the position information selected on the screen and the information indicating that a button is pressed to the control unit 170 as input signals.

The sound processing unit 140 performs modulation and demodulation of a sound signal. The sound processing unit 140 modulates a signal supplied from the microphone 141, and supplies the modulated signal to the control unit 170. In addition, the sound processing unit 140 supplies the sound signal to the speaker 142. The sound processing unit 140 is realized by, for example, a processor for sound processing. The microphone 141 accepts a sound input, and supplies a sound signal corresponding to the sound input to the sound processing unit 140. The speaker 142 converts the sound signal supplied from the sound processing unit 140 to sound, and outputs the sound to the outside of the terminal device 10.

The display 150 displays data such as an image, a moving image, and a text, according to control by the control unit 170. The display 150 is realized by, for example, an LCD (liquid crystal display) or an organic EL (electro-luminescence) display.

The storage unit 160 is constituted by, for example, a flash memory or the like, and stores data and programs used by the terminal device 10. In a certain aspect, the storage unit 160 stores user information 161.

The user information 161 is information of the user who uses the terminal device 10 to perform registration for employment request, presentation of recruitment information, application for the recruitment information, and the like, which are functions of the employment registrant management system 1. The user information includes information (user ID) for identifying the user, the name of the user, organization information of a company or the like to which the user belongs, and the like.

The control unit 170 controls the operation of the terminal device 10 by reading a program stored in the storage unit 160, and executing instructions included in the program. The control unit 170 is, for example, an application installed in the terminal device 10 in advance. The control unit 170 demonstrates the functions as an input operation accepting unit 171, a transmission and reception unit 172, a data processing unit 173, and a notification control unit 174 by operating according to the program.

The input operation accepting unit 171 performs processing of accepting an input operation by the user to the input device of keyboard 131 and the like.

The transmission and reception unit 172 performs processing for the terminal device 10 to transmit and receive data to and from an external device such as the server 20 according to a communication protocol.

The data processing unit 173 performs, according to a program, processing of performing calculation on data the input of which is received by the terminal device 10, and outputting the calculation result to a memory or the like.

The notification control unit 174 performs processing of presenting information to the user. The notification control unit 174 performs processing of causing the display 150 to display a display image, processing of causing the speaker 142 to output sound, and the like.

### <1.2 Functional Configuration of Server 20>

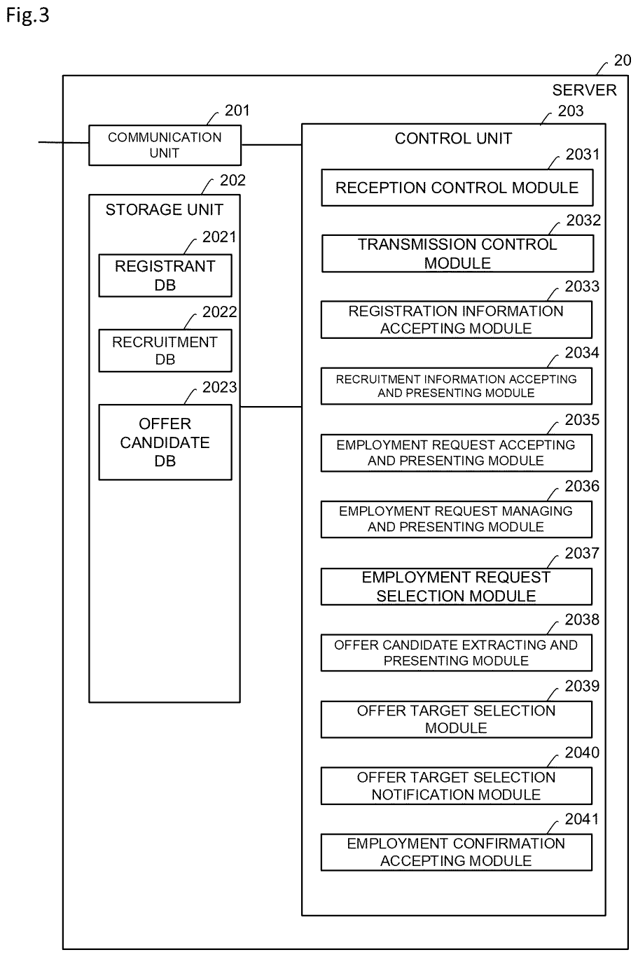

FIG. 3 is a diagram illustrating a functional configuration of the server 20 constituting the employment registrant management system 1 of Embodiment 1. As illustrated in FIG. 3, the server 20 demonstrates the functions as a communication unit 201, a storage unit 202, and a control unit 203.

The communication unit 201 performs processing for the server 20 to communicate with the external device.

The storage unit 202 stores data and programs used by the server 20. The storage unit 202 stores a registrant database 2021, a recruitment database 2022, an offer candidate database 2023, and the like.

The registrant database 2021 is a database for holding the information of the registrants registered for employment request in the employment registrant management system 1, and is configured to, for example, separately register the respective attributes of the registrants. In addition, the registrant database 2021 stores, in association with the information of the registrants, the employment request information to which the registrants applied, the employment schedule information indicating determined employment of the registrants, and the employment information indicating that the registrants are employed by the business entities based on the employment request information or the offer information. Details will be described later.

The recruitment database 2022 is a database for holding the recruitment information registered by the business entities utilizing the employment registrant management system 1, specifically, the information of shifts on the assumption of short-term employment, and the like. Details will be described later.

The offer candidate database 2023 is a database for holding the information regarding the registrants who are offer candidates that are obtained by extracting the registrants who may be employed by the business entities utilizing the employment registrant management system 1. Details will be described later.

When the processor 29 of the server 20 performs processing according to a program, the control unit 203 demonstrates, as various modules, the functions illustrated by a reception control module 2031, a transmission control module 2032, a registration information accepting module 2033, a recruitment information accepting and presenting module 2034, an employment request accepting module 2035, an employment request managing and presenting module 2036, an employment request selection module 2037, an offer candidate extracting and presenting module 2038, an offer target selection accepting module 2039, an offer target selection notification module 2040, and an employment confirmation accepting module 2041.

The reception control module 2031 controls the processing in which the server 20 receives a signal from the external device according to a communication protocol.

The transmission control module 2032 controls the processing in which the server 20 transmits a signal to the external device according to the communication protocol.

The registration information accepting module 2033 controls the processing of accepting registration information from the terminal device 10, since a person who requests employment, who is a user using the employment registrant management system 1, operates the terminal device 10 to input registration information for registering as a registrant for employment at a business entity. The registration information accepting module 2033 accepts the registration information as a registrant who belongs to the business entity that is, for example, a manager or an operator of a store such as a retail store or a restaurant. Here, the registrant who belongs to the business entity may be an employee (internal employee) who is directly hired by the business entity, a former internal employee who was previously hired by the business entity as a full-time employee but already retired, i.e., a so-called OB and OG, a person who was hired by the business entity for a short term (for example, even one day is allowed), or further, a person who is only registered for employment by the business entity and has not been actually employed. The registration information of the registrant may be accepted by, for example, the introduction from another registrant (may be any of an internal employee, an external experienced person, or an external person) who has been already registered as a registrant who belongs to the business entity, and in that case, the information of the registrant who is an introducer may also be accepted.

The registrant accepted by the registration information accepting module 2033 may be, in addition to the registrant who belongs to the business entity as described above, for example, an administrator that is a company operating one or more stores such as retail stores or restaurants, or a person who belongs to an administrator that is a company conducting a franchise chain business, or may be a registrant who does not belong to a specific business entity or administrator.

Upon acceptance of the registration information, the registration information accepting module 2033 classifies and registers each registrant as a different attribute depending on whether the registrant is an internal employee, an external experienced person, or an external person, and stores the registrant in, for example, the registrant database 2021. In addition, the registration information accepting module 2033 classifies and registers each registrant as a different attribute depending on whether the registrant is a person who belongs to a business entity, a person who belongs to an administrator, or a person who does not belong to a specific business entity or administrator, and stores the registrant in, for example, the registrant database 2021. At this time, the registration information accepting module 2033 accepts, for example, information such as the name, address, registration location (school, regular workplace, or the like) other than address, contact information, gender, age, and the like of the registrant. Furthermore, the information of skills based on the past career of the registrant or the information of qualification related to employment is accepted as skill information. The skill information s specifically the information of experience of specific business (customer service, cooking experience at restaurants, and the like), and the information of qualification and license.

The recruitment information accepting and presenting module 2034 controls the processing of accepting an input of recruitment information from the terminal device 10, since the business entity, which is a user using the employment registrant management system 1, operates the terminal device 10 to input the recruitment information. The recruitment information input by the business entity may be, for example, recruitment information of working hours during which workers such as student part-timers and part-timers work in retail stores and restaurants on the assumption of short-term (one-time) employment, i.e., so-called shifts, or may be information of additional recruitment for missing shifts. Specifically, the recruitment information accepting and presenting module 2034 accepts, as the recruitment information, information of the company name or store name of the business entity, the job title or work name related to employment, the number of persons to be recruited, the unit price of wages for a predetermined time period, and the like.

In addition, the recruitment information accepting and presenting module 2034 controls the processing of presenting, to the registrant, the accepted recruitment information corresponding to the attribute of the registrant to whom the recruitment information is to be presented. When accepting the recruitment information from the business entity, the recruitment information accepting and presenting module 2034 accepts the information indicating the range of attributes of registrants to whom the recruitment information is to be presented for viewing, and corresponding to the range, the recruitment information accepting and presenting module 2034 controls whether to present the recruitment information to internal employees only, to present the recruitment information to internal employees, external experienced persons, and external persons, to present the recruitment information to the extent of registrants who belong to the business entity, to present the recruitment information to the extent of registrants who belong to an administrator, or to present the recruitment information to the extent of registrants who do not belong to a specific business entity or administrator, and presents the recruitment information to the relevant registrants. Specifically, since the registrant operates the terminal device 10 to view the recruitment information, the recruitment information accepting and presenting module 2034 determines the attribute of the registrant based on a user ID that identifies the registrant, and transmits the recruitment information corresponding to the attribute of the registrant to the terminal device 10 to cause the terminal device 10 to display the recruitment information. In addition, the recruitment information accepting and presenting module 2034 stores the accepted recruitment information in, for example, the recruitment database 2022. Furthermore, the employment request accepting module 2035 displays, on the terminal device 10, together with the recruitment information, inputting means (for example, an application button) for inputting an employment request for the recruitment information.

Furthermore, the recruitment information accepting and presenting module 2034 may transmit, to the terminal device 10, together with the recruitment information, inputting means (for example, an application button) for inputting an employment request for the recruitment information, and cause the terminal device 10 to display the recruitment information and the inputting means. Note that the recruitment information accepting and presenting module 2034 may present a calendar to the business entity, and prompt the business entity to select the employment period related to the recruitment information from the corresponding date(s) on the calendar to accept the recruitment information.

The employment request accepting module 2035 controls the processing of accepting employment request information from the terminal device 10, since the registrant, who is the user using the employment registrant management system 1, operates the terminal device 10 to apply for the recruitment information to input the employment request information for which the registrant requests employment. The employment request accepting module 2035 accepts the employment request information from the registrant with relevant attributes corresponding to the range of attributes of registrants presented by the recruitment information accepting and presenting module 2034. The employment request accepting module 2035 accepts, as the employment request information, for example, information such as the user ID for identifying the registrant, the company name or store name of the business entity for which employment is requested, the job title or work name for which employment is requested, the starting and ending dates and times of work in a case where the recruitment information is recruitment information (shifts) that assumes short-time employment.

In addition, the employment request accepting module 2035 accepts, from the registrant, the employment request information for the recruitment information, and accepts the response deadline for response information to the employment request information. The employment request accepting module 2035 accepts an input of the response deadline requested by the registrant until, for example, the employment period related to the recruitment information. At this time, the employment request accepting module 2035 may transmit, to the terminal device 10, the date and time of the response deadline between the current time and the time of employment related to the recruitment information to present it in a selectable manner, or may present it until the time a predetermined time period (may be one day, or the time it takes for the registrant to travel to the work place related to the recruitment information) before the time of employment related to the recruitment information.

Furthermore, the employment request accepting module 2035 may automatically calculate the response deadline for the employment request information, and transmit and present it to the terminal device 10, or may present the response deadline calculated by the registrant in a changeable manner. At this time, the employment request accepting module 2035 may automatically calculate the response deadline based on the employment period related to the recruitment information, specifically, the time set by the business entity that has input the recruitment information, or may calculate the time that is prior to the response deadline by a time period required for preparation for employment related to the recruitment information (for example, the time it takes for the registrant to travel to the work pace related to the recruitment information, and the time calculated from the time period required for preparation work such as changing clothes).

Note that the employment request accepting module 2035 may allow specifying requested employment hours that is different from the scheduled date and time of employment of the recruitment information. For example, when the employment hours are 9:00 to 18:00 in the information of scheduled date and time of employment that is input by the business entity, although an employment request is generally accepted only when one is available to work in all of these hours, even when one is available to work in hours shorter than these hours, it may be allowed to accept an employment request by inputting, for example, 9:00 to 15:00 for the requested employment hours. In addition, the employment request accepting module 2035 stores the accepted employment request information in, for example, the registrant database 2021 and the offer candidate database 2023. Furthermore, the employment request accepting module 2035 may present a calendar to the registrant, display the employment period related to the recruitment information on the dates of the calendar, and accept the employment request information by allowing selection from it. In addition, the employment request accepting module 2035 may link the accepted employment request information to, for example, a calendar tool such as Google calendar or Outlook (registered trademark).

The employment request managing and presenting module 2036 controls the processing of transmitting and presenting the employment request information accepted by the employment request accepting module 2035 to the terminal device 10 of the business entity that has input the recruitment information. The employment request managing and presenting module 2036 classifies the employment request information into, for example, the internal employee, the external experienced person, and the external person, according to the attributes of the registrant who requests employment, and presents it to the business entity. In addition, the employment request managing and presenting module 2036 classifies the employment request information into, for example, the registrant who belongs to the business entity, the registrant who belongs to the administrator, and the registrant who does not belong to a specific business entity or administrator, according to the attributes of the registrant who requests employment, and presents it to the business entity. Note that, for the employment request information, the employment request managing and presenting module 2036 may present a calendar to the business entity, and present the employment period related to the recruitment information on the corresponding date(s) on the calendar.

In addition, the employment request managing and presenting module 2036 transmits and presents, together with the employment request information, the response deadline for response information to the employment request information accepted by the employment request accepting module 2035 to and on the terminal device 10 of the business entity that has input the recruitment information.

For the employment request information accepted by the employment request accepting module 2035, the employment request managing and presenting module 2036 presents the employment request information of the registrant whose response deadline has not elapsed to the business entity as the currently applying information. The registrant of the currently applying information can be described to be in, for example, a state where the business entity is aware that the response deadline for the registrant has not elapsed, or has not become aware of it, and a state before the business entity determines whether or not to hire the registrant as a person to be actually employed. Note that the employment request information of the registrant whose response deadline has elapsed is presented to the business entity as offer candidate information, which will be described later.

Furthermore, for the employment request information accepted by the employment request accepting module 2035, the employment request managing and presenting module 2036 may also notify the registrant whose response deadline has elapsed of the information that the response deadline has elapsed on the terminal device 10 of the registrant. The employment request managing and presenting module 2036 displays the information that the response deadline has elapsed on the terminal device 10 as, for example, a pop-up screen.

Since the business entity selects the registrant to be actually employed from the employment request information presented by the employment request managing and presenting module 2036, and operates the terminal device 10 to input the selection result, the employment request selection module 2037 controls the processing of accepting, from the terminal device 10, the information of the registrant the selection result for whom is to be hired, that is, to be employed. At this time, the employment request selection module 2037 may register the status information for the registrant as, for example, employment determined. In addition, the employment request selection module 2037 notifies the selected registrant of the information that the selected registrant has been selected by the business entity on the terminal device 10 of the registrant.

Note that the employment request selection module 2037 may allow adjustment to and selection of hours for the requested employment hours specified by the registrant. For example, in a case where the requested employment hours specified by the registrant is 9:00 to 15:00, when it is acceptable for the business entity if the employment hours are 9:00 to 14:00, the employment hours may be changed and input as 9:00 to 14:00, so as to be selectable. In addition, the employment request selection module 2037 stores the status information for which the selection by the business entity has been performed in, for example, the recruitment database 2022. In addition, for the selection from the employment request information, the employment request selection module 2037 may present a calendar showing the employment period related to the recruitment information to the business entity, and may accept the selection by selecting the corresponding date(s) on the calendar.

When registrants selected by the employment request selection module 2037 are less than the number of staff numbers (the number of shifts) actually required, and there is an opening for recruitment, the offer candidate extracting and presenting module 2038 controls the processing of extracting registrants who may be employed by the business entity as offer candidate information, at the time when the business entity that has input the recruitment information selects registrants who are actually to be employed. The offer candidate extracting and presenting module 2038 extracts registrants who may be employed by the business entity that has input the recruitment information as offer candidate information, based on the employment request information applied to the business entity that has input the recruitment information or other business entities, or the employment schedule information at the business entity that has input the recruitment information or the other business entities. Here, the employment request information refers to the information of application for the recruitment information of a business entity, and the employment schedule information refers to the schedule information that one is hired for the recruitment information of the business entity and is determined to be employed. The offer candidate extracting and presenting module 2038 may further extract registrants who may be employed by the business entity that has input the recruitment information as the offer candidate information, based on either or both of the information of the registrants and the employment information at the business entity that has input the recruitment information or other business entities. For example, upon request from the business entity, or in an input screen for selecting registrants, the offer candidate extracting and presenting module 2038 calculates the possibility of actually being employed when selected by the business entity, and extracts registrants who may be employed as the offer candidate information. Specifically, the employment hours, the distance from the address or registration location of registrants to the employment location, and the like are referred to as the information of the registrants. In addition, the work experience at the business entity or administrator, the work experience in the same type of business as the business entity or administrator, the work experience in the same franchise chain business as the business entity or administrator, and the like are referred to as the employment information of the registrants. When extracting registrants as the offer candidate information, the offer candidate extracting and presenting module 2038 obtains the information of the registrants or the employment information of the registrants with reference to, for example, the registrant database 2021.

Specific examples of offer candidates extracted by the offer candidate extracting and presenting module 2038 will be described below. The employment request information that a registrant has applied for the recruitment information of a business entity is registered in the registrant database 2021, regardless of whether or not being hired before the date and time of the recruitment elapses, and whether or not being actually employed after the date and time of the recruitment elapsed. It is conceivable that, before the date and time of the recruitment elapses, this registrant is highly likely to be available for employment at the same date and time as the date and time of the recruitment information for which the registrant applied, even at those other than the business entity and administrator. In addition, it is conceivable that this registrant is highly likely to be available for employment at the same day of the week as the employment date of the recruitment information for which the registrant applied, the same day of a different month, or the hours that are the same as or similar to the employment hours of the recruitment information for which the registrant applied, at the business entity or even at those other than the business entity and administrator. At this time, it is conceivable that this registrant is highly likely to be available for employment even at those other than the business entity and administrator, unless the employment location (for example, a store) is not a remote location to which the registrant cannot commute. Furthermore, it is conceivable that this registrant is highly likely to be available for employment even at those other than the business entity and administrator, in the case of the recruitment information for the business type and industry that are the same as the business type and industry of the business entity, the case of the recruitment information for the business type and industry of a franchise chain that are the same as business type and industry of the business entity, or the case of the recruitment information for a plurality of stores (other employment locations) in a case where the business entity manages the plurality of stores of the same brand or a plurality of different brands. That is, it can be said that the registrant as described above is a potential registrant who can be employed by the business entity, or by those other than the business entity and administrator.

Therefore, the offer candidate extracting and presenting module 2038 determines the registrant as described above to be a registrant who is highly likely to be available for employment even at those other than the business entity and administrator, for the recruitment information of the same date and time as, for example, the employment date and time of the recruitment information for which the registrant applied, and extracts the registrant as described above as the offer candidate information. In addition, the offer candidate extracting and presenting module 2038 determines the registrant as described above to be a registrant who is highly likely to be available for employment at the business entity or even at those other than the business entity and administrator, for the recruitment information of the same day of the week as the employment date of the recruitment information for which the registrant applied, the same day of a different month, or the hours that are the same as or similar to the employment hours of the recruitment information for which the registrant applied, and extracts the registrant as described above as the offer candidate information. In addition, when the employment location of the recruitment information for which the registrant applied is not a remote location to which the registrant cannot commute, the offer candidate extracting and presenting module 2038 determines the registrant as described above to be a registrant who is highly likely to be available for employment even at those other than the business entity and administrator, and extracts the registrant as described above as the offer candidate information. Furthermore, in the case of the recruitment information for the business type and industry that are the same as the business type and industry of the business entity of the recruitment information for which the registrant applied, the case of the recruitment information for the business type and industry of a franchise chain that are the same as business type and industry of the business entity, or the case of the recruitment information for a plurality of stores (other employment locations) in a case where the business entity manages the plurality of stores of the same brand or a plurality of different brands, the offer candidate extracting and presenting module 2038 determines the registrant as described above to be a registrant who is highly likely to be available for employment even at those other than the business entity and administrator, and extracts the registrant as described above as the offer candidate information.

The offer candidate extracting and presenting module 2038 may obtain the schedule information indicating the schedule of a registrant (a person who can be employed by the business entity, or by those other than the business entity and administrator) from, for example, a calendar tool, which is a function provided by the employment registrant management system 1 (may be a function of the terminal device 10 on which an application provided by the employment registrant management system 1 is installed), and extract the offer candidate information with reference to this schedule information. As a specific example, in a case where a certain registrant has registered the schedule information indicating availability for employment, when the registrant meets the conditions to be extracted as an offer candidate as described above, the registrant is determined to be highly likely to be available for employment, and the registrant is extracted as the offer candidate information. In addition, when a certain registrant has registered some schedule information, even when the registrant meets the conditions to be extracted as the offer candidate as described above, the registrant is determined to be unlikely to be available for employment since the schedule information has been registered, and the registrant is not extracted as the offer candidate information. Assume that a certain registrant regularly (for example, every week, every month, or the like) registers some schedule information at fixed hours. Examples of this schedule information include the schedule of lectures and seminars in a case where the registrant is a student, the schedule for hospital visits (accompany) by the registrant himself/herself or a family member, the employment schedule in a case where the registrant is employed by a business entity other than the user that uses the employment registrant management system 1. In this case, even when the registrant meets the conditions to be extracted as the offer candidate as described above, it is determined that the registrant is unlikely to be available for employment for the employment information overlapping with the regular schedule, and the registrant is not extracted as the offer candidate information. However, in the case of the employment information of the day(s) when there are no regular schedules as described above, it is determined that there is no regular schedule for some reason (for example, cancellation of a lecture, or the like), and the registrant is extracted as the offer candidate information. Note that the offer candidate extracting and presenting module 2038 may perform the above-described processing in cooperation with a calendar tool such as Google calendar or Outlook.

As specific processing, when there is an opening in the recruitment, the offer candidate extracting and presenting module 2038 compares the recruitment information with the information of the registrants stored in the registrant database 2021, and extracts the registrants who are determined to be relevant as the offer candidate information. At this time, the offer candidate extracting and presenting module 2038 compares, for example, the information such as the recruiting job type, date and time of the recruitment information, and the information indicating the situations of the registrants as described above (application situations, schedule, status, and the like).

For the employment request information accepted by the employment request accepting module 2035, the offer candidate extracting and presenting module 2038 may extract the employment request information of the registrant whose response deadline has elapsed as the offer candidate information. It is because a registrant whose response deadline has elapsed is considered to be in a state where the response deadline has elapsed before a business entity determines whether to hire the registrant as a person to be actually employed, or a state where it has been once determined not to hire the registrant, and thus it is conceivable that the registrant is highly likely to be able to accept an offer.

In addition, the offer candidate extracting and presenting module 2038 controls the processing of transmitting and presenting the information of the registrants extracted as the offer candidates to the terminal device 10 of the business entity that has input the recruitment information. The offer candidate extracting and presenting module 2038 classifies the registrants extracted as the offer candidates into, for example, the internal employee, the external experienced person, and the external persons, according to the attributes of the registrants, and presents it to the business entity. In addition, the offer candidate extracting and presenting module 2038 classifies the registrants extracted as the offer candidates into, for example, the registrant who belongs to the business entity, the registrant who belongs to the administrator, and the registrant who does not belong to a specific business entity or administrator, according to the attributes of the registrants, and presents it to the business entity.

Furthermore, the offer candidate extracting and presenting module 2038 calculates, for each registrant, the matching rate indicating the possibility that the registrant presented as the offer candidate information is actually employed when selected by the business entity, and presents the matching rate to the business entity. When calculating the matching rate, as in the case of extracting the registrant as the offer candidate information, the offer candidate extracting and presenting module 2038 refers to the information of the registrant, the employment information of the registrant, or both, and calculates the possibility of actually being employed when selected by the business entity.

In addition, the offer candidate extracting and presenting module 2038 stores the information of the registrants extracted as the offer candidates in the offer candidate database 2023.

Since the business entity selects the registrant to be actually employed as an offer target from the offer candidate information presented by the offer candidate extracting and presenting module 2038, and operates the terminal device 10 to input the selection result, the offer target selection accepting module 2039 controls the processing of accepting, from the terminal device 10, the information of the registrant the selection result for whom is to be hired, that is, to be employed. At this time, the offer target selection accepting module 2039 may register, for example, the status information for the registrant as already offered.

The offer target selection notification module 2040 controls the processing of notifying the registrant selected as the offer target for the opening in the recruitment information, which is accepted by the offer target selection accepting module 2039, of the information indicating that the registrant has been selected by the business entity on the terminal device 10 of the registrant. In the offer target selection notification module 2040, the information that the registrant has been selected by the business entity is displayed on the terminal device 10 as, for example, a pop-up screen.

Note that the offer target selection notification module 2040 may control the processing of publishing documents required for employment, for example, documents such as a notice of working conditions and an attendance record, for the selected registrant. For the registrants to be actually employed, since the types of documents required for employment are different depending on the attributes of the registrants, the offer target selection notification module 2040 publishes the documents required for employment corresponding to the attributes of the registrants.

The employment confirmation accepting module 2041 controls the processing of accepting, from a registrant, a response that the registrant is to be employed to the notification that the registrant has been selected as the offer target by the business entity from the offer target selection notification module 2040. At this time, for example, when the employment confirmation accepting module 2041 accepts, from a registrant to whom an offer has been made, a response that the registrant is to be employed, the employment confirmation accepting module 2041 may register the status information for the registrant as employment determined. Furthermore, when the employment confirmation accepting module 2041 accepts, from a registrant, a response that the registrant is to be employed, the employment confirmation accepting module 2041 may issue a notification to the business entity.

### <2 Data Structure>

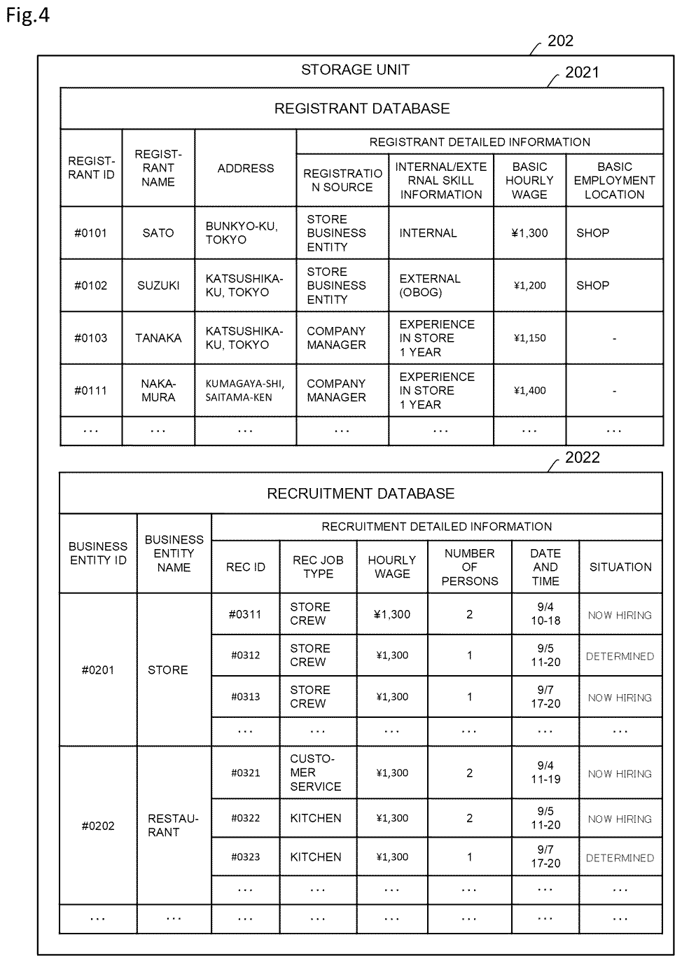

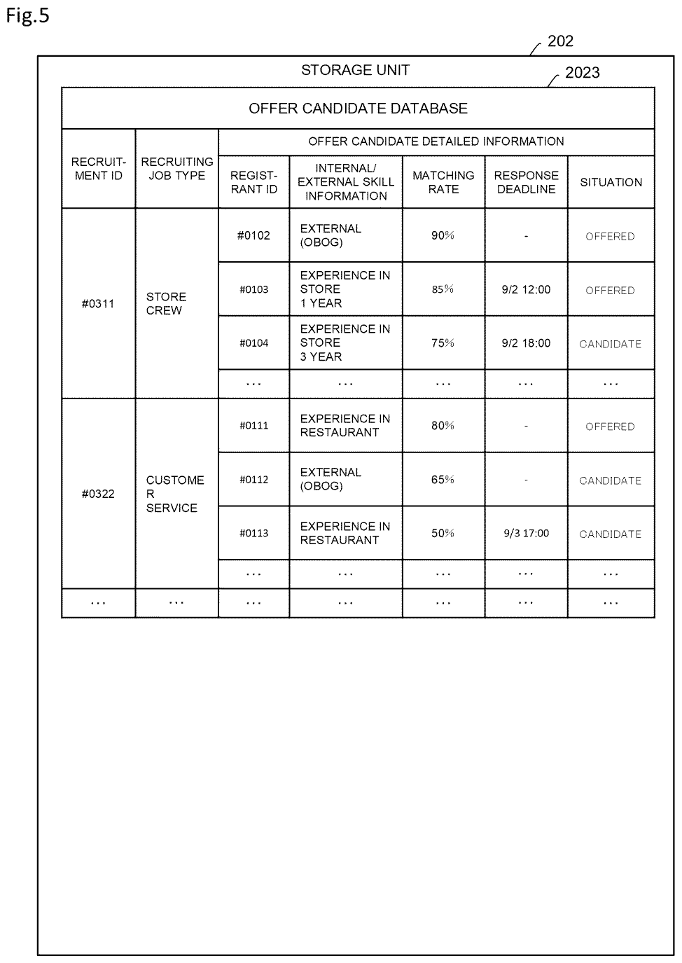

FIG. 4 is a diagram illustrating examples of data structures of the registrant database 2021 and the recruitment database 2022 stored in the server 20. In addition, FIG. 5 is a diagram illustrating an example of data structure of the offer candidate database 2023 stored in the server 20.

As illustrated in FIG. 4, each record of the registrant database 2021 includes an item “registrant ID”, an item “registrant name”, an item “address”, an item “registrant detailed information”, etc.

The item “registrant ID” is the information for identifying each registrant accepted by the employment registrant management system 1 for an employment request.

The item “registrant name” is the name of the registrant accepted by the employment registrant management system 1 for the employment request.

The item “address” is the address of the registrant accepted by the employment registrant management system 1 for the employment request. Note that, in this item, a registration location (school, regular workplace, or the like) other than the address may be stored.

The item “registrant detailed information” is the information regarding the registrant accepted by the employment registrant management system 1 for the employment request, and specifically includes an item “registration source”, an item “internal/external skill information”, an item “basic hourly wage”, an item “basic employment location”, etc.

The item “registration source” is the information indicating the attribute of the registrant who has registered in the employment registrant management system 1 for the employment request. Specifically, the information indicating whether the registrant is a registrant who belongs to an administrator or a registrant who does not belong to a specific business entity or administrator, and the information of the business entity or administrator are stored.

The information indicating whether the registrant who has registered in the employment registrant management system 1 for the employment request is the internal employee, the external experienced person, or the external person, and the skill information of the registrant are stored in the item “internal/external skill information.”

The item “hourly wage” is the information indicating the unit price of the salary in a predetermined time period in a case where the registrant who has registered in the employment registrant management system 1 for the employment request is employed, and the hourly wage is illustrated as an example. This information of the hourly wage may be, for example, the hourly wage that is usually paid by the business entity or administrator in the case of the registrant who belongs to the business entity or administrator, or may be the hourly wage at the time of registration or the hourly wage based on the past achievements.

The item “basic employment location” is the information indicating the location such as a store where the registrant who has registered in the employment registrant management system 1 for the employment request is usually employed.

Note that, although illustration is omitted, the registrant database 2021 may hold the information regarding employment situations.

When registration information is accepted from a user, the registration information accepting module 2033 of the server 20 adds a record to the registrant database 2021.

Each record of the recruitment database 2022 includes an item “business entity ID”, an item “business entity name”, an item “recruitment detailed information”, etc.

The item “business entity ID” is the information for identifying each business entity that registers recruitment information with the employment registrant management system 1.

The item “business entity name” is the information indicating the name of the business entity that registers the recruitment information with the employment registrant management system 1, and for example, the name of a store, the name of a corporation, or the name of an individual business owner are stored.

The item “recruitment detailed information” is the information regarding the recruitment information registered in the employment registrant management system 1 by the business entity, and specifically includes an item “recruitment ID”, an item “recruiting job type”, an item “hourly wage”, an item “number of persons”, an item “date and time”, an item “situation”, etc. This item “recruitment detailed information” is configured so that a record is registered each time the business entity represented by the item “business entity name” registers recruitment information.

The item “recruitment ID” is the information for identifying each recruitment information registered in the employment registrant management system 1 by the business entity.

The item “recruiting job type” is the information indicating the job type related to the recruitment information registered in the employment registrant management system 1 by the business entity. Specifically, it is the work content in the case of actually being employed for the recruitment, and in the example illustrated in FIG. 4, “store crew” that performs various kinds of work in a store of a convenience store chain, and “store customer service” that performs customer service in a store of a restaurant.

The item “hourly wage” is the information indicating the unit price of the salary in the predetermined time period in the case of actual employment for the recruitment registered in the employment registrant management system 1 by the business entity, and the hourly wage is illustrated as an example.

The item “number of persons” is the information indicating the number of persons for the recruitment information registered in the employment registrant management system 1 by the business entity.

The item “date and time” stores the information indicating the scheduled employment date and time of a shift in the recruitment information registered in the employment registrant management system 1 by the business entity.

The item “situation” is the information indicating the situation related to the recruitment information registered in the employment registrant management system 1 by the business entity, and “now hiring” indicating that hiring is in process, “selection in progress” indicating that application is closed and selection of registrants is in progress, “determined” indicating that the registrant to be actually employed has been determined, or the like is stored.

When the recruitment information is accepted from the user, the recruitment information accepting and presenting module 2034 of the server 20 adds a record to the item “recruitment detailed information” of the recruitment database 2022.

As illustrated in FIG. 5, each record of the offer candidate database 2023 includes an item “recruitment ID”, an item “recruiting job type”, an item “offer candidate detailed information”, etc.

The item “recruitment ID” is the information for identifying each recruitment information registered in the employment registrant management system 1 by the business entity, and corresponds to the item “recruitment ID” in the item “recruitment detailed information” of the recruitment database 2022.

The item “recruiting job type” is the information indicating the job type related to the recruitment information registered in the employment registrant management system 1 by the business entity, and corresponds to the item “recruiting job type” in the item “recruitment detailed information” of the recruitment database 2022.

The item “offer candidate detailed information” is the information regarding registrants who are offer candidates for the recruitment information registered in the employment registrant management system 1 by the business entity, and specifically includes an item “registrant ID”, an item “internal/external skill information”, an item “matching rate”, an item “response deadline”, an item “situation”, etc. This item “offer candidate detailed information” is configured so that a record is registered each time a registrant registers employment request information.

The item “registrant ID” is the information for identifying each registrant accepted by the employment registrant management system 1 for an employment request, and corresponds to the item “registrant ID” of the registrant database 2021.

The item “internal/external skill information” is the information indicating whether the registrant who has registered in the employment registrant management system 1 for the employment request is the internal employee, the external experienced person, or the external person, and the skill information of the registrant, and corresponds to the item “internal/external skill information” of the registrant database 2021.

The item “matching rate” is the percentage indicating the possibility that a registrant is actually employed when selected by the business entity in the case where the registrant who has registered in the employment registrant management system 1 for the employment request is an offer candidate, and the value calculated by the offer candidate extracting and presenting module 2038 is stored.

The item “response deadline” is the response deadline for response information to the employment request information accepted by the registrant who has registered in the employment registrant management system 1 for the employment request. The date and time accepted by the employment request accepting module 2035 in the case where the registrant applied for the recruitment information has become an offer candidate since the response deadline elapsed is stored.

The item “situation” is the information indicating the situation related to employment of the registrant who has registered in the employment registrant management system 1 for the employment request, and “candidate” indicating that the registrant is offer candidate information, “offer” indicating that an offer has been made by the business entity, or the like is stored.

When an instruction for extracting offer candidates is accepted from the business entity, the offer candidate extracting and presenting module 2038 of the server 20 adds a record to the item “offer candidate detailed information” of the offer candidate database 2023.

### <3 Operation>

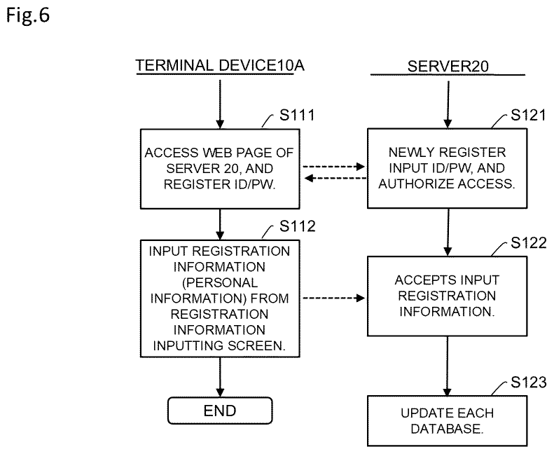

Hereinafter, referring to FIG. 6 to FIG. 9, a description will be given of registration processing, recruitment information accepting processing, and employment request information accepting processing by the employment registrant management system 1 in a first embodiment. Note that, in FIG. 6 to FIG. 9, it is assumed that a terminal device used by a registrant is the terminal device 10A, and a terminal device used by a business entity is the terminal device 10B.

FIG. 6 is a flowchart illustrating an example of a flow for performing the registration processing by the employment registrant management system 1 in Embodiment 1.

In step S111, the input operation accepting unit 171 of the terminal device 10A accepts, from the user who registers as a registrant for employment for the business entity, an operation of inputting a user ID and a password for performing authentication required for utilizing services of the employment registrant management system 1. The transmission and reception unit 172 transmits the accepted user ID and password, and the user information to the server 20. The transmission and reception unit 172 of the terminal device 10A accepts the authentication completion information, and the display data of a registration information inputting screen for accepting registration information that are transmitted from the server 20. The notification control unit 174 displays the accepted authentication completion information and registration information inputting screen on the display 150.

In step S121, the server 20 accepts the user ID and the password transmitted from the terminal device 10A via the communication unit 201, verifies that the user ID and the password of the user are valid, and performs predetermined authentication. When valid, the server 20 transmits the authentication completion information to the terminal device 10A via the communication unit 201. In addition, the registration information accepting module 2033 of the server 20 transmits the display data of the registration information inputting screen for accepting registration information to the terminal device 10A via the communication unit 201.

In step S112, the input operation accepting unit 171 of the terminal device 10A accepts an input of the registration information registered by the user, specifically, personal information, skill information, and the like of the registrant, through an operation by the user. The transmission and reception unit 172 transmits the accepted registration information to the server 20.

In step S122, the registration information accepting module 2033 of the server 20 accepts the registration information transmitted from the terminal device 10A via the communication unit 201. The registration information accepting module 2033 classifies each registrant according to different attributes depending on whether the registrant is the internal employee, the external experienced person, or the external person. In addition, the registration information accepting module 2033 distinguishes the accepted registration information between the registration information from the registrant who belongs to the business entity, the registrant who belongs to the administrator, and the registrant who does not belong to a specific business entity or administrator, based on the information of the location where registration is made (for example, a link source to a registration screen) or the like, and classifies each registrant as a different attribute.

In step S123, the registration information accepting module 2033 of the server 20 classifies the registration information accepted in step S122 as described above, and stores it in the registrant database 2021.

As described above, in the employment registrant management system 1, when the registration information is accepted from the user who registers as a registrant for employment for the business entity, each registrant is classified and registered as a different attribute.

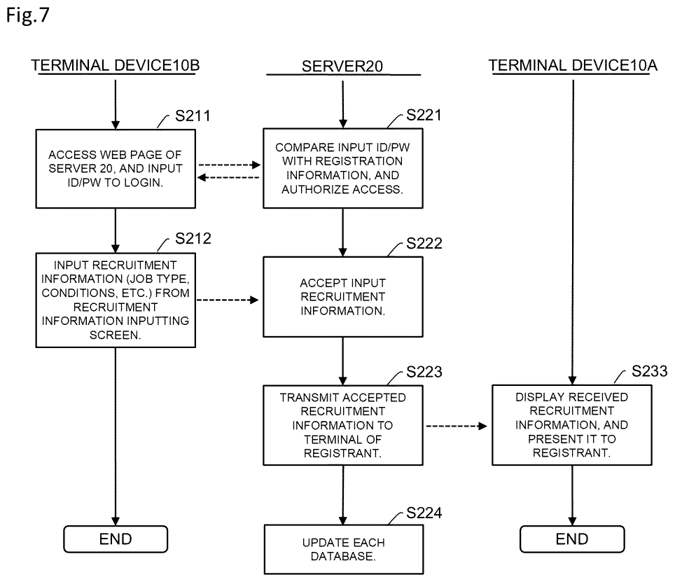

FIG. 7 is a flowchart illustrating an example of a flow for performing the recruitment information accepting processing by the employment registrant management system 1 in Embodiment 1.

In step S211, the input operation accepting unit 171 of the terminal device 10B accepts, from the user that is the business entity registering the recruitment information, an operation of inputting the user ID and the password for performing authentication required to utilize services of the employment registrant management system 1. The transmission and reception unit 172 transmits the accepted user ID and password, and the user information to the server 20. The transmission and reception unit 172 of the terminal device 10B accepts the authentication completion information and the display data of the recruitment information inputting screen for accepting the recruitment information that are transmitted from the server 20. The notification control unit 174 displays the accepted authentication completion information and recruitment information inputting screen on the display 150.

In step S221, the server 20 accepts the user ID and the password transmitted from the terminal device 10B via the communication unit 201, verifies that the user ID and the password of the user are valid, and performs the predetermined authentication. When valid, the server 20 transmits the authentication completion information to the terminal device 10B via the communication unit 201. In addition, the recruitment information accepting and presenting module 2034 of the server 20 transmits the display data of the recruitment information inputting screen for accepting the recruitment information to the terminal device 10B via the communication unit 201.

In step S212, the input operation accepting unit 171 of the terminal device 10B accepts, through an operation by the user, an input of the recruitment information registered by the user, specifically, the company name or store name of the business entity, the job title or work name related to employment, the number of persons to be recruited, the information of the unit price of the salary in a predetermined time period, the information indicating the range of registrants to whom the recruitment information is presented for viewing, and the like, as the recruitment information. The transmission and reception unit 172 transmits the accepted recruitment information to the server 20.

In step S222, the recruitment information accepting and presenting module 2034 of the server 20 accepts the recruitment information transmitted from the terminal device 10B via the communication unit 201.

In step S223, the recruitment information accepting and presenting module 2034 of the server 20 accepts, for the recruitment information accepted in step S222, the information indicating the range of attributes of the registrants to whom the recruitment information is presented for viewing, and corresponding to the range, controls whether to present it to the internal employee only, whether to present it to the internal employee, the external experienced person, and the external person, whether to present it to the extent of the registrant who belongs to the business entity, whether to present it to the extent of the registrant who belongs to the administrator, or whether to present it to the extent of the registrant who does not belong to a specific business entity or administrator, so as to present it to the relevant registrant. The recruitment information accepting and presenting module 2034 controls the range to be presented so as to correspond to the range of attributes of the registrants to be presented, and transmits the recruitment information (or the information indicating that the recruitment information has been updated) to the terminal device 10A for the relevant registrant via the communication unit 201.

In step S233, the transmission and reception unit 172 of the terminal device 10A accepts the recruitment information (or the information indicating that the recruitment information has been updated) transmitted from the server 20. The notification control unit 174 displays the accepted recruitment information on the display 150.

In step S224, the recruitment information accepting and presenting module 2034 of the server 20 stores the recruitment information accepted in step S222 in the recruitment database 2022.

As described above, when the recruitment information is accepted from the user that is the business entity, the employment registrant management system 1 presents it to the registrant according to the attributes of registrants to whom the recruitment information is to be presented. Accordingly, the business entity can register the recruitment information according to the attributes of the registrants, and can utilize human resources other than its own registrants when necessary, while giving priority to its own registrants.

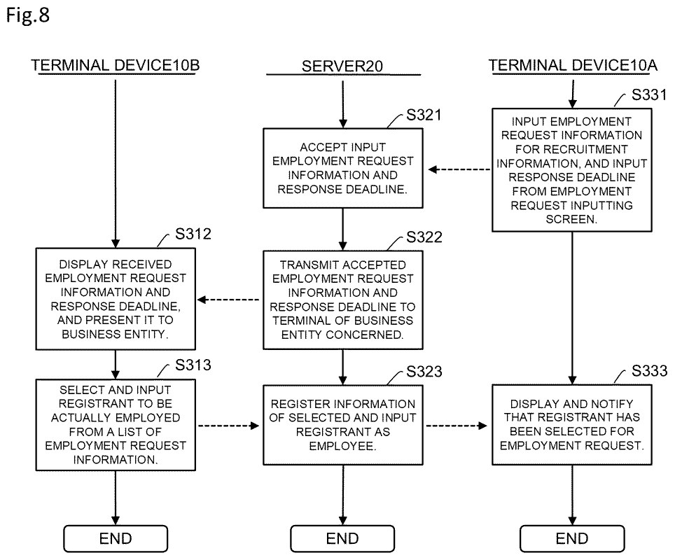

FIG. 8 is a flowchart illustrating an example of a flow for performing the employment request information accepting processing by the employment registrant management system 1 in Embodiment 1.

In step S331, the input operation accepting unit 171 of the terminal device 10A accepts, through an operation by the user, an input of the employment request information registered by the user, specifically, the user ID for identifying the registrant who requests employment, the company name or store name of the business entity for which employment is requested, the job title or work name for which employment is requested, the starting and ending dates and times of work in a case where the recruitment information is recruitment information (shifts) that assumes short-time employment, and the like. Furthermore, the input operation accepting unit 171 accepts, through an operation by the user, together with the employment request information registered by the user, an input of the response deadline for response information to the employment request information. The transmission and reception unit 172 transmits the accepted employment request information and response deadline to the server 20.

In step S321, the employment request accepting module 2035 of the server 20 accepts the employment request information and the response deadline transmitted from the terminal device 10A via the communication unit 201.

In step S322, the employment request managing and presenting module 2036 of the server 20 transmits, to the terminal device 10B via the communication unit 201, the employment request information accepted in step S321 so as to be displayed by being classified into, for example, the internal employee, the external experienced person, and the external person according to the attributes of the registrants who request employment. In addition, the employment request managing and presenting module 2036 transmits, to the terminal device 10B via the communication unit 201, the employment request information accepted in step S321 so as to be displayed by being classified into, for example, the registrant who belongs to the business entity, the registrant who belongs to the administrator, and the registrant who does not belong to a specific business entity or administrator, according to the attributes of the registrant who requests employment. At this time, the employment request managing and presenting module 2036 transmits, to the terminal device 10B via the communication unit 201, together with the employment request information, the response deadline for response information to the employment request information accepted in step S321.

In step S312, the transmission and reception unit 172 of the terminal device 10B accepts the employment request information and the response deadline transmitted from the server 20. The notification control unit 174 classifies the accepted employment request information and response deadline according to the attributes of the registrants, and displays it on the display 150.

In step S313, the input operation accepting unit 171 of the terminal device 10B accepts, through an operation by the user, an input by the business entity, which is the user, for selecting the registrant to be actually employed for its own recruitment. The transmission and reception unit 172 transmits the accepted information of the registrants to the server 20.

In step S323, the employment request selection module 2037 of the server 20 accepts, via the communication unit 201, the information transmitted from the terminal device 10B and indicating that the registrant to be actually employed for the recruitment has been selected. The employment request selection module 2037 transmits, to the terminal device 10A via the communication unit 201, the accepted notification for the selected registrant related to the employment request information that the registrant has been selected by the business entity.

In step S333, the transmission and reception unit 172 of the terminal device 10A accepts the notification transmitted from the server 20 and indicating that the registrant has been selected by the business entity. The notification control unit 174 displays the accepted notification that the registrant has been selected by the business entity on the display 150.

As described above, the employment registrant management system 1 accepts the employment request information from the registrant, and also accepts the response deadline for response information to the employment request information. Accordingly, it is possible to set the response deadline from the business entity when the registrant applies for the recruitment information.

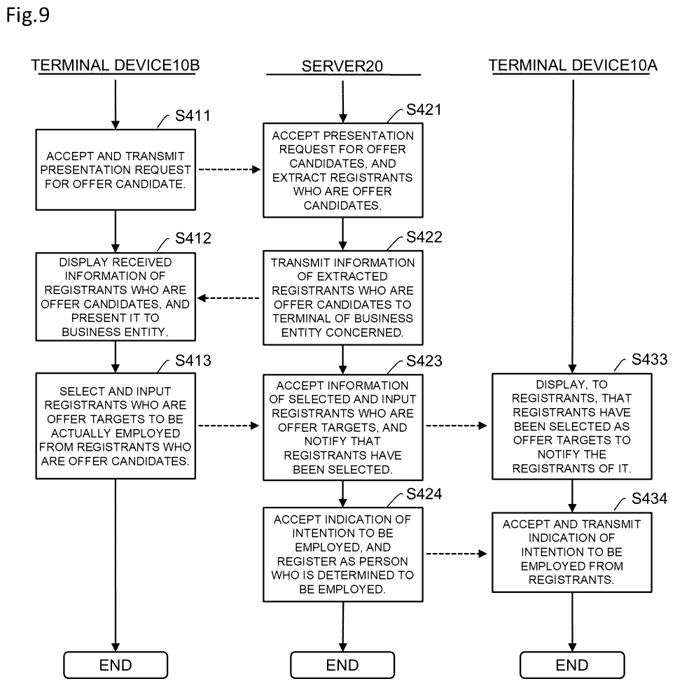

FIG. 9 is a flowchart illustrating an example of a flow for performing the offer target accepting processing by the employment registrant management system 1 in Embodiment 1.

In step S411, when there is an opening in the shifts of the business entity, the input operation accepting unit 171 of the terminal device 10B accepts, through an operation by the user, which is the business entity, an input operation for instructing extraction of registrants who may be employed by the business entity as the offer candidate information. The transmission and reception unit 172 transmits the accepted presentation request to the server 20.

In step S421, the offer candidate extracting and presenting module 2038 of the server 20 accepts the presentation request of the offer candidate information transmitted from the terminal device 10B via the communication unit 201. The offer candidate extracting and presenting module 2038 calculates the possibility of actually being employed when selected by the business entity, and extracts registrants who may be employed as the offer candidate information.

For example, in step S421, for the recruitment that is stored in the offer candidate database 2023 illustrated in FIG. 5, and that has “#0311” for the item “recruitment ID” and “store crew” for the item “recruiting job type”, the registrant having “#0103” for the item “registrant ID”, who has experience in the same business type as the business type and industry of the business entity even though the work experience is under those other than the business entity and administrator, is extracted as an offer candidate. At this time, when the above-described registrant has applied for, for example, the recruitment information of the same day of the week as the employment day of the above-described recruitment information, the same day of a different month, or the hours the same as or similar to the employment hours of the recruitment information for which the registrant has applied, it is determined that the registrant is highly likely to be available for employment. Furthermore, for example, when the employment location of the above-described recruitment information is not a remote location where the above-described registrant cannot commute, it is determined that the registrant is highly likely to be available for employment even under those other than the business entity or administrator.

In step S422, the offer candidate extracting and presenting module 2038 of the server 20 transmits the information of the registrants who are the offer candidates extracted in step S421 to the terminal device 10B via the communication unit 201.

In step S412, the transmission and reception unit 172 of the terminal device 10B accepts the information of the registrants who are the offer candidates transmitted from the server 20. The notification control unit 174 classifies the accepted information of the registrants who are the offer candidates according to the attributes of the registrants, and displays it on the display 150.

In step S413, the input operation accepting unit 171 of the terminal device 10B accepts, through an operation by the user, an input by the business entity, which is the user, for selecting the registrant to be actually employed for its own recruitment as an offer target. The transmission and reception unit 172 transmits the accepted information of the registrants who are the offer targets to the server 20.

In step S423, the offer target selection accepting module 2039 of the server 20 accepts, via the communication unit 201, the information transmitted from the terminal device 10B and indicating that the registrant to be actually employed for the recruitment has been selected as the offer target. The offer target selection notification module 2040 of the server 20 transmits, to the terminal device 10A via the communication unit 201, the accepted notification for the registrant who is the offer target that the registrant has been selected by the business entity.

In step S433, the transmission and reception unit 172 of the terminal device 10A accepts the notification transmitted from the server 20 and indicating that the registrant has been selected as the offer target by the business entity. The notification control unit 174 displays the accepted notification that the registrant has been selected as the offer target by the business entity on the display 150.

In step S434, the input operation accepting unit 171 of the terminal device 10A accepts, through an operation by the user, a response from the registrant that the registrant will be employed to the notification that the registrant has been selected as the offer target by the business entity. The transmission and reception unit 172 transmits the accepted response that the registrant will be employed to the server 20.

In step S424, the employment confirmation accepting module 2041 accepts, via the communication unit 201, the response transmitted from the terminal device 10A and indicating that the registrant will be employed.

As described above, the employment registrant management system 1 accepts the employment request information from the registrant, and also accepts the response deadline for response information to the employment request information. Accordingly, it is possible to offer the registrants (workers) who may be employed by the business entity to be employed as needed.

### <4 Screen Example>

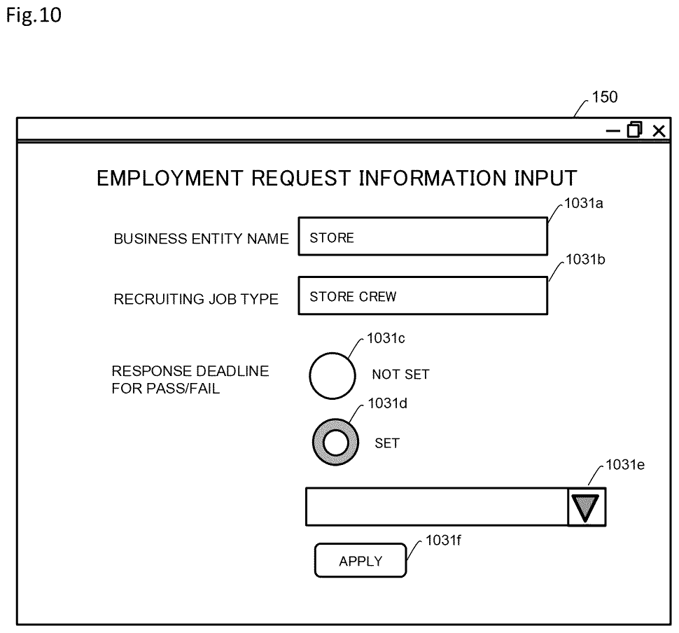

Hereinafter, referring to FIG. 10 to FIG. 12, a description will be given of an example of a screen that accepts an employment request from a registrant, an example of a screen that displays employment applicants, and an example of a screen that displays offer candidates that are displayed by the employment registrant management system 1.

FIG. 10 is a diagram illustrating an example of a screen that accepts an employment request and that is displayed on the terminal device 10. The example of the screen in FIG. 10 illustrates an example of a screen in a state where the registration information inputting screen is displayed for a user registered as a registrant for employment by a business entity to apply for the recruitment information to input employment request information. It corresponds to step S331 in FIG. 8.

As illustrated in FIG. 10, the employment request information inputting screen for the registrant to input the employment request information for the recruitment information is displayed on the display 150 of the terminal device 10. A business entity name display column 1031a and a recruiting job type display column 1031b of the recruitment information are displayed on this employment request information inputting screen as the entered information. In addition, the employment request information inputting screen is provided with setting selection buttons 1031c and 1031d for selecting whether or not to set the response deadline for response information to employment request information, and a response deadline input column 1031e. The setting selection buttons 1031c and 1031d consist of, for example, as illustrated in FIG. 10, the setting selection button 1031c that is to be selected when not setting a response deadline, and the setting selection button 1031d that is to be selected when setting a response deadline. The response deadline input column 1031e is an input column to which the response deadline is to be input when the setting selection button 1031d is selected, and is configured so that the date and time can be selected through, for example, a pull-down menu or the like as illustrated in FIG. 10. Furthermore, an apply button 1031f for transmitting the employment request information to the server 20 is provided.

In the screen illustrated in FIG. 10, the user, who is the registrant inputting the employment request information, determines whether or not to set the response deadline by selecting the setting selection button 1031c or 1031d, and when set, inputs the response deadline to the response deadline input column 1031e, and presses the apply button 1031f, so that the employment request information for the recruitment information is transmitted, and the response deadline for response information to the employment request information can be set.

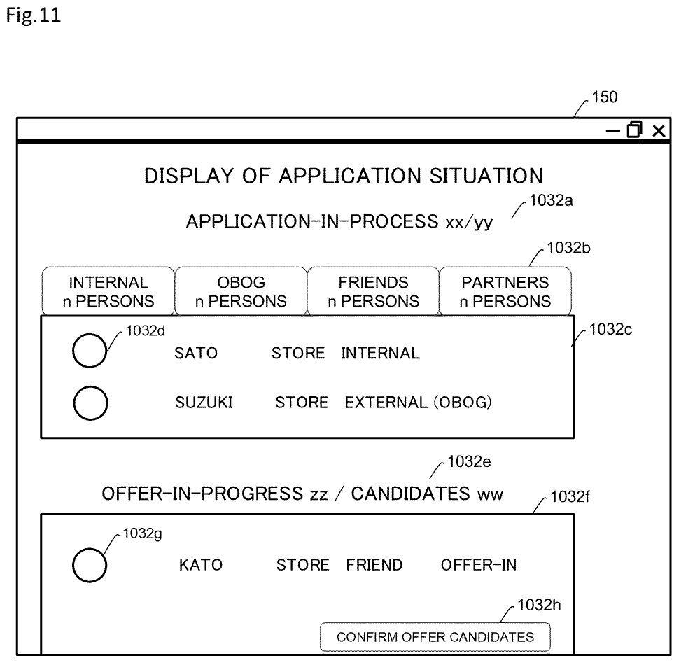

FIG. 11 is a diagram illustrating an example of a screen that displays employment applicants and that is displayed on the terminal device 10. The example of the screen in FIG. 11 illustrates an example of a screen in a state where the application situation of employment applicants who have applied to the recruitment information is displayed for the user, which is the business entity. It corresponds to step S312 in FIG. 8.

As illustrated in FIG. 11, an application situation display screen showing the application situation of employment applicants who have applied for the recruitment information is displayed on the display 150 of the terminal device 10. This application situation display screen is provided with a column 1032a for displaying the number of persons applying that indicates the number of persons of those who request employment as the application-in-process information for which the response deadline has not elapsed, an attribute selection column 1032b for displaying employment applicants according to the attributes, an employment applicant display column 1032c for displaying the relevant employment applicants whose application is in process, an offer number display column 1032e for showing the number of registrants as the information of those to whom offer has been made or who are the offer candidates, and an offered registrant display column 1032f for displaying the relevant employment applicants to whom offer has been made or who are the offer candidates. In addition, selection buttons 1032d for selecting employees (employed persons) from the employment applicants in the employment applicant display column 1032c, and a selection button 1032g for selecting an employee (employed person) from the employment applicants in the offered registrant display column 1032f are provided. Furthermore, a confirmation button 1032h for viewing the detailed information of the employment applicant who is the offer candidate from registrants displayed in the offered registrant display column 1032f is provided.

In the screen illustrated in FIG. 11, when the response deadline has elapsed, the employment applicants whose application is in process and who are displayed in the employment applicant display column 1032c are moved to the offered registrant display column 1032f as the offer candidates. In addition, the user, which is the business entity, can select employees (employed persons) by selecting the selection buttons 1032d and 1032g when selecting the employees (employed persons). In addition, when viewing the detailed information of the employment applicants who are the offer candidates, confirmation can be performed by pressing the confirmation button 1032h.

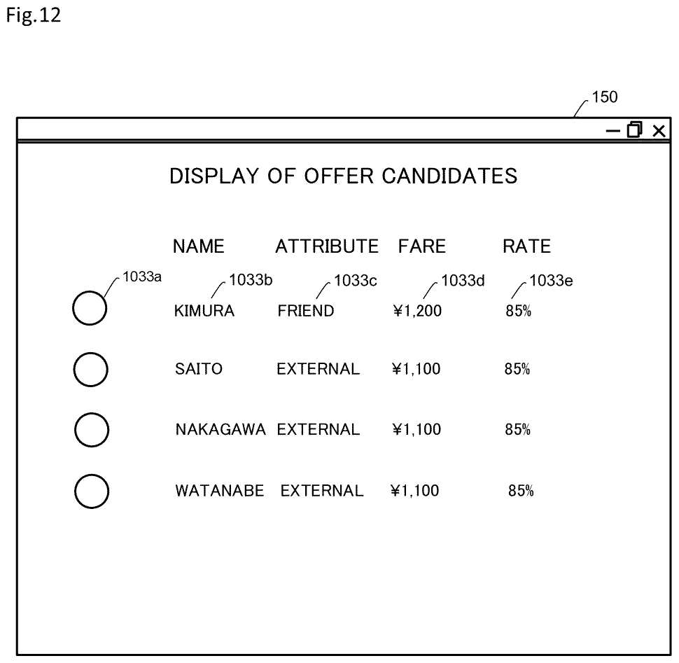

FIG. 12 is a diagram illustrating an example of a screen that displays offer candidates and that is displayed on the terminal device 10. The example of the screen in FIG. 12 illustrates an example of a screen in a state where the user, which is the business entity, has pressed the confirmation button 1032h illustrated in FIG. 11, and the detailed information of the registrants who are the offer candidates is displayed. It corresponds to step S412 in FIG. 9.

As illustrated in FIG. 12, an offer candidate situation display screen showing the detailed situation of the registrants who are the offer candidates is displayed on the display 150 of the terminal device 10. This offer candidate situation display screen is provided with selection buttons 1033a for selecting employees (employed persons), a registrant name display column 1033b, a registrant attribute display column 1033c, a transportation expenses display column 1033d showing the transportation expenses of registrants, and a matching rate display column 1033e showing the matching rates of the registrants.

In the screen illustrated in FIG. 11, the user, which is the business entity, refers to the matching rates displayed in the matching rate display column 1033e when selecting an employee (employed person), and selects the selection button 1033a, so that it is possible to select an employee (employed person) who is highly likely to be employed.

### SUMMARY

As described above, according to the present embodiment, for an opening in the recruitment information (shifts), registrants (workers) who may be employed by the business entity are extracted as the offer candidate information, and is presented to the business entity. When an input for selecting, from these registrants who are offer candidates, a registrant to be actually employed as an offer target is accepted, the registrant is notified that the registrant has been selected as the offer target. Accordingly, it is possible to offer registrants (workers) who may be employed by the business entity to be employed as needed. Accordingly, it becomes possible to facilitate new employment for securing required shifts.

In addition, the employment request information for the recruitment information is accepted from the user who is registered as the registrant for employment at the business entity, and the response deadline for response information to the employment request information is also accepted. Therefore, when the registrant applies for the recruitment information, it becomes possible to set the response deadline from the business entity according to the registrant's own convenience. Accordingly, it becomes possible to obtain, at an appropriate time, a response as to whether or not the registrant can be employed for the applied recruitment information.

Furthermore, the matching rate indicating the possibility that the registrant presented as the offer candidate information is actually employed when selected by the business entity is calculated, and is presented to the business entity. Accordingly, it becomes possible to determine whether or not the registrant will be employed when hired, and whether or not the registrant is highly likely to be employed.

### Second Embodiment

Hereinafter, another embodiment of the employment registrant management system 1 will be described.

### <1 General Configuration of Employment Registrant Management System 1>

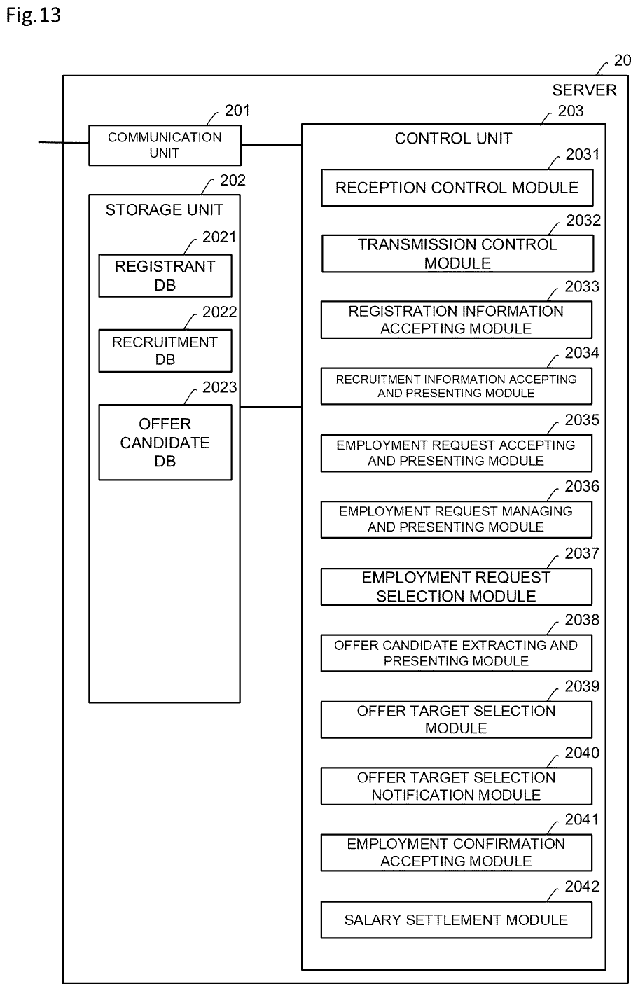

FIG. 13 is a diagram illustrating a functional configuration of a server 20 constituting an employment registrant management system 1 in Embodiment 2. Since the general configuration of the employment registrant management system 1 and the configuration of the terminal device 10 in the second embodiment are the same as those in the first embodiment, the description will not be repeated. As illustrated FIG. 13, the configuration of the server 20 is the same as that in the first embodiment, except for newly including the function of a salary settlement module 2042. Hereinafter, the function of the salary settlement module 2042 in the second embodiment will be described.

The salary settlement module 2042 controls the processing of performing settlement of salary payment related to employment of a selected registrant, who is accepted by the employment request selection module 2037, or by the offer target selection accepting module 2039. The salary settlement module 2042 performs salary calculation related to employment of registrants by, for example, classifying the registrants according to the attributes of the registrants registered in the registrant database 2021. It is because the various conditions on which the salary calculation is based are different depending on the attributes of the registrants. At this time, the salary settlement module 2042 may be configured to accept, from the business entity, the evaluation information regarding the employment of the registrants. The evaluation information may be, for example, quantitative evaluation information, such as which of the five levels the registrant belongs to, or may be qualitative evaluation information such as comments.

### <2 Data Structure>

Since the data structure in the second embodiment is the same as that in the first embodiment, the description will not be repeated.

### <3 Operation>

Since the operation in the second embodiment is the same as that in the first embodiment, the description will not be repeated.

### SUMMARY

As described above, according to the present embodiment, the settlement of the salary payment related to the employment of the registrants selected by the business entity is performed. Accordingly, the labor force can be more efficiently secured, and the procedures after employment can be efficiently processed.

Although embodiments according to the disclosure have been described above, these can be implemented in other various modes, and can be implemented by making various kinds of omissions, substitutions, and changes. These embodiments and modifications, and those to which omissions, substitutions, and changes have made are included in the technical scope of the claims and its equivalent scope.

### SUPPLEMENT

The matters described in each of the above-described embodiments are supplemented as follows.

(Supplement 1) An information processing apparatus for managing registrants registered for employment, the information processing apparatus comprising the control unit 203 and the storage unit 202, wherein the storage unit 202 stores (2021) information of the registrants, employment request information to which the registrants applied, and past employment information of the registrants, and the control unit 203 performs the steps of accepting an input of recruitment information from a business entity, and presenting the recruitment information to the registrants (S223), accepting, from the registrants, employment request information for the recruitment information (S321), accepting the employment request information, and presenting the employment request information to the business entity that has input the recruitment information (S322), accepting, from the business entity that has input the recruitment information, an input for selecting the registrants who are to be actually employed (S324), for an opening in the recruitment information, extracting, as offer candidate information, registrants who may be employed by the business entity that has input the recruitment information, based on the employment request information at the business entity that has input the recruitment information or other business entities, or employment schedule information indicating determined employment at the business entity that has input the recruitment information or the other business entities, and when the business entity that has input the recruitment information selects a registrant who is to be actually employed, presenting the registrants to the business entity that has input the recruitment information (S421), accepting, from the business entity that has input the recruitment information, an input for selecting, as offer targets, the registrants who are to be actually employed, from the registrants presented as the offer candidate information (S422), and notifying the registrants selected as the offer targets by the business entity that has input the recruitment information that the registrants have been selected as the offer targets for the opening in the recruitment information by the business entity that has input the recruitment information (S423).

(Supplement 2) An information processing apparatus according to (supplement 1), wherein, in the step of extracting the registrants as the offer candidate information, the registrants are extracted as the offer candidate information further based on information including either or both of the information of the registrants and the past employment information at the business entity that has input the recruitment information or other business entities.

(Supplement 3) An information processing apparatus according to (supplement 2), wherein the program further performs a step of calculating, for each of the registrants, a matching rate indicating a possibility that the registrants presented as the offer candidate information are actually employed by the business entity that has input the recruitment information, and presents the matching rate for each of the registrants in the step of presenting the registrants as the offer candidate information.

(Supplement 4) An information processing apparatus according to (supplement 3), wherein, in the step of calculating the matching rate, the matching rate is calculated based on information including either or both of the information of the registrants and the past employment information of the registrants.

(Supplement 5) An information processing apparatus according to any one of (supplement 1) to (supplement 4), wherein the program further performs a step of accepting, from the registrants selected as the offer targets by the business entity that has input the recruitment information, a response for performing employment related to the recruitment information, and presenting the registrants as employed persons to the business entity that has input the recruitment information.

(Supplement 6) An information processing apparatus according to (supplement 5), wherein, in the step of accepting, from the registrants, the employment request information for the recruitment information, a response deadline to the employment request information is accepted.

(Supplement 7) An information processing apparatus according to (Supplement 6), wherein, in the step of accepting the response deadline, the response deadline is automatically calculated and presented to the registrants.

(Supplement 8) An information processing apparatus according to (supplement 7), wherein the calculated response deadline is presented to be changeable by the registrants.

(Supplement 9) An information processing apparatus according to (supplement 8), wherein the response deadline is calculated based on information including an employment period related to the recruitment information.

(Supplement 10) An information processing apparatus according to (supplement 9), wherein the program further performs a step of notifying the registrants whose response deadlines have elapsed that the response deadlines have elapsed.

(Supplement 11) An information processing apparatus according to (supplement 10), wherein the program further performs a step of presenting a calendar to the business entity that has input the recruitment information, and presenting an employment period related to the recruitment information on the calendar.

(Supplement 12) An information processing apparatus according to (supplement 11), wherein, in the step of accepting the recruitment information from the business entity that has input the recruitment information, selection of date and time on the calendar from the business entity that has input the recruitment information is accepted, and the recruitment information is accepted.

(Supplement 13) An information processing apparatus according to (supplement 12), wherein the program further performs a step of presenting a calendar to the registrants whose employment request information has been accepted, and presenting a period of the employment request information on the calendar.

(Supplement 14) An information processing apparatus according to (supplement 13), wherein the memory classifies and stores the information of the registrants according to attributes of the registrants, and in the step of presenting the registrants as the offer candidate information, the registrants are presented to the business entity that has input the recruitment information by being classified according to the attributes of the registrants.

(Supplement 15) An information processing apparatus according to (supplement 14), wherein the attributes of the registrants are stored by being classified into an internal employee hired by a specific business entity, an external employee previously hired by the specific business entity, and an external person not currently or previously hired by the specific business entity.

(Supplement 16) A method for managing registrants registered for employment, the method being executed by the computer comprising the processor 29 and the memory 25, wherein the memory 25 stores (2021) information of the registrants, employment request information to which the registrants applied, and past employment information of the registrants, and in the method, the processor 29 performs the steps of accepting an input of recruitment information from a business entity, and presenting the recruitment information to the registrants (S223), accepting, from the registrants, employment request information for the recruitment information (S321), accepting the employment request information, and presenting the employment request information to the business entity that has input the recruitment information (S322), accepting, from the business entity that has input the recruitment information, an input for selecting the registrants who are to be actually employed (S324), for an opening in the recruitment information, extracting, as offer candidate information, registrants who may be employed by the business entity that has input the recruitment information, based on the employment request information at the business entity that has input the recruitment information or other business entities, or employment schedule information indicating determined employment at the business entity that has input the recruitment information or the other business entities, and when the business entity that has input the recruitment information selects a registrant who is to be actually employed, presenting the registrants to the business entity that has input the recruitment information (S421), accepting, from the business entity that has input the recruitment information, an input for selecting, as offer targets, the registrants who are to be actually employed, from the registrants presented as the offer candidate information (S422), and notifying the registrants selected as the offer targets by the business entity that has input the recruitment information that the registrants have been selected as the offer targets for the opening in the recruitment information by the business entity that has input the recruitment information (S423).

(Supplement 17) A non-transitory computer readable medium that stores a program that is to be executed by processing circuitry, and that is for managing registrants registered for employment, the program being executed by the computer including the processor 29 and the memory 25, wherein the memory 25 stores (2021) information of the registrants, employment request information applied by the registrants, and past employment information of the registrants, the program causes the processor 29 to perform the steps of accepting an input of recruitment information from a business entity, and presenting the recruitment information to the registrants (S223), accepting, from the registrants, the employment request information for the recruitment information (S321), accepting the employment request information, and presenting the employment request information to the business entity that has input the recruitment information (S322), accepting, from the business entity that has input the recruitment information, an input for selecting the registrants who are to be actually employed (S324), for an opening in the recruitment information, extracting, as offer candidate information, registrants who may be employed by the business entity that has input the recruitment information, based on the employment request information at the business entity that has input the recruitment information or other business entities, or employment schedule information indicating determined employment at the business entity that has input the recruitment information or the other business entities, and when the business entity that has input the recruitment information selects the registrants who are to be actually employed, presenting the registrants to the business entity that has input the recruitment information (S421), accepting, from the business entity that has input the recruitment information, an input for selecting, as offer targets, the registrants who are to be actually employed, from the registrants presented as the offer candidate information (S422), and notifying the registrants selected as the offer targets by the business entity that has input the recruitment information that the registrants have been selected as the offer targets for the opening in the recruitment information by the business entity that has input the recruitment information (S423).

### REFERENCE SIGNS LIST

10: Terminal device
20: Server
80: Network
130: Operation accepting unit
161: User information
22: Communication IF
23: Input/output IF
25: Storage
26: Processors
29: Server
201: Communication unit
202: Storage unit
2021: Registrant database
2022: Recruitment database
2023: Offer candidate database
203: Control unit

1. An information processing apparatus for managing registrants registered for employment, the information processing apparatus comprising a control unit and a storage unit, wherein
the storage unit stores information of the registrants, employment request information to which the registrants applied, and employment information of the registrants, and
the control unit performs steps of:
accepting an input of recruitment information from a business entity, and presenting the recruitment information to the registrants;
accepting, from the registrants, the employment request information for the recruitment information;
accepting the employment request information, and presenting the employment request information to the business entity that has input the recruitment information;
accepting, from the business entity that has input the recruitment information, an input for selecting the registrants who are to be actually employed from the employment request information;
for an opening in the recruitment information, extracting, as offer candidate information, the registrants who may be employed by the business entity that has input the recruitment information, based on the employment request information at the business entity that has input the recruitment information or other business entities, or employment schedule information indicating determined employment at the business entity that has input the recruitment information or the other business entities, and when the business entity that has input the recruitment information selects the registrants who are to be actually employed, presenting the registrants to the business entity that has input the recruitment information;
accepting, from the business entity that has input the recruitment information, an input for selecting, as offer targets, the registrants who are to be actually employed, from the registrants presented as the offer candidate information; and
notifying the registrants selected as the offer targets by the business entity that has input the recruitment information that the registrants have been selected as the offer targets for the opening in the recruitment information by the business entity that has input the recruitment information.

2. The information processing apparatus according to claim 1, wherein, in the step of extracting the registrants as the offer candidate information, the registrants are extracted as the offer candidate information further based on information including either or both of the information of the registrants and the employment information at the business entity that has input the recruitment information or other business entities.

3. The information processing apparatus according to claim 2, wherein the program further
performs a step of calculating, for each of the registrants, a matching rate indicating a possibility that the registrants extracted as the offer candidate information are actually employed by the business entity that has input the recruitment information, and
presents the matching rate for each of the registrants in the step of presenting the registrants as the offer candidate information.

4. The information processing apparatus according to claim 3, wherein, in the step of calculating the matching rate, the matching rate is calculated based on information including either or both of the information of the registrants and the employment information of the registrants.

5. The information processing apparatus according to claim 1, wherein the program further
performs a step of accepting, from the registrants selected as the offer targets by the business entity that has input the recruitment information, a response for performing employment related to the recruitment information, and presenting the registrants as employed persons to the business entity that has input the recruitment information.

6. The information processing apparatus according to claim 5, wherein, in the step of accepting, from the registrants, the employment request information for the recruitment information, a response deadline to the employment request information is accepted.

7. The information processing apparatus according to claim 6, wherein, in the step of accepting the response deadline, the response deadline is automatically calculated and presented to the registrants.

8. The information processing apparatus according to claim 7, wherein the calculated response deadline is presented to be changeable by the registrants.

9. The information processing apparatus according to claim 8, wherein the response deadline is calculated based on information including an employment period related to the recruitment information.

10. The information processing apparatus according to claim 9, wherein the program further
performs a step of notifying the registrants whose response deadlines have elapsed that the response deadlines have elapsed.

11. The information processing apparatus according to claim 10, wherein the program further
performs a step of presenting a calendar to the business entity that has input the recruitment information, and presenting an employment period related to the recruitment information on the calendar.

12. The information processing apparatus according to claim 11, wherein, in the step of accepting the recruitment information from the business entity that has input the recruitment information, selection of date and time on the calendar from the business entity that has input the recruitment information is accepted, and the recruitment information is accepted.

13. The information processing apparatus according to claim 12, wherein the program further
performs a step of presenting a calendar to the registrants whose employment request information has been accepted, and presenting a period of the employment request information on the calendar.

14. The information processing apparatus according to claim 13, wherein the memory classifies and stores the information of the registrants according to attributes of the registrants, and
in the step of presenting the registrants as the offer candidate information, the registrants are presented to the business entity that has input the recruitment information by being classified according to the attributes of the registrants.

15. The information processing apparatus according to claim 14, wherein the attributes of the registrants are stored by being classified into an internal employee hired by a specific business entity, an external employee previously hired by the specific business entity, and an external person not currently or previously hired by the specific business entity.

16. A method for managing registrants registered for employment, the method being executed by a computer comprising a processor and a memory, wherein
the memory stores information of the registrants, employment request information to which the registrants applied, and employment information of the registrants, and
in the method, the processor performs steps of:
accepting an input of recruitment information from a business entity, and presenting the recruitment information to the registrants;
accepting, from the registrants, the employment request information for the recruitment information;
accepting the employment request information, and presenting the employment request information to the business entity that has input the recruitment information;
accepting, from the business entity that has input the recruitment information, an input for selecting the registrants who are to be actually employed from the employment request information;
for an opening in the recruitment information, extracting, as offer candidate information, the registrants who may be employed by the business entity that has input the recruitment information, based on the employment request information at the business entity that has input the recruitment information or other business entities, or employment schedule information indicating determined employment at the business entity that has input the recruitment information or the other business entities, and when the business entity that has input the recruitment information selects the registrants who are to be actually employed, presenting the registrants to the business entity that has input the recruitment information;
accepting, from the business entity that has input the recruitment information, an input for selecting, as offer targets, the registrants who are to be actually employed, from the registrants presented as the offer candidate information; and
notifying the registrants selected as the offer targets by the business entity that has input the recruitment information that the registrants have been selected as the offer targets for the opening in the recruitment information by the business entity that has input the recruitment information.

17. A non-transitory computer readable medium that stores a program that is to be executed by processing circuitry, and that is for managing registrants who are registered for employment, wherein
the medium stores information of the registrants, employment request information applied by the registrants, and employment information of the registrants,
the program causes the processor to perform steps of:
accepting an input of recruitment information from a business entity, and presenting the recruitment information to the registrants;
accepting, from the registrants, the employment request information for the recruitment information;
accepting the employment request information, and presenting the employment request information to the business entity that has input the recruitment information;
accepting, from the business entity that has input the recruitment information, an input for selecting the registrants who are to be actually employed from the employment request information;
for an opening in the recruitment information, extracting, as offer candidate information, the registrants who may be employed by the business entity that has input the recruitment information, based on the employment request information at the business entity that has input the recruitment information or other business entities, or employment schedule information indicating determined employment at the business entity that has input the recruitment information or the other business entities, and when the business entity that has input the recruitment information selects the registrants who are to be actually employed, presenting the registrants to the business entity that has input the recruitment information;
accepting, from the business entity that has input the recruitment information, an input for selecting, as offer targets, the registrants who are to be actually employed, from the registrants presented as the offer candidate information; and
notifying the registrants selected as the offer targets by the business entity that has input the recruitment information that the registrants have been selected as the offer targets for the opening in the recruitment information by the business entity that has input the recruitment information.
